(19) United States
(12) Patent Application Publication
(10) Pub. No.: US 2015/0281758 A1
(43) Pub. Date: Oct. 1, 2015

(54) WebCinema

(71) Applicant: Reilly Johnson, Harrisburg, PA (US)

(72) Inventor: Reilly Johnson, Harrisburg, PA (US)

(21) Appl. No.: 14/668,983

(22) Filed: Mar. 26, 2015

Related U.S. Application Data
(60) Provisional application No. 61/970,437, filed on Mar. 26, 2014.

(51) Int. Cl. H04N 21/262; H04N 21/258; H04N 21/61

(52) U.S. Cl. CPC H04N 21/26225; H04N 21/6125; H04N 21/25875

(57) ABSTRACT

The technology of WebCinema is an online viewing platform that allows the public to view first-run movies on internet-capable electronic devices. WebCinema transforms the current state of new-movie viewing technology by allowing consumers to have complete choice. For 100 years, the public has been forced to view new-release movies the same old way—they had to travel to a theater. Or, we could wait for many months and finally view a movie on Blu-ray/DVD, On-Demand, or through a subscription service. Technology now makes it possible for today's modern society to have control, convenience and choice over their movie viewing options. WebCinema is not just a new and useful process for viewing first-run movies, it provides people with that control, convenience, and choice. WebCinema also eradicates all the inconveniences and problems of traveling to the movie theater (see paragraph 15). New-movie viewing will finally, and legally, expand beyond the theater and directly to the viewer!

### CROSS-REFERENCE TO RELATED APPLICATIONS

This nonprovisional patent application is claiming the benefit of a prior-filed provisional patent application under 35 U.S.C. § 119(e) and 37 C.F.R. 1.78(a), and is presenting a reference to the prior application in an application data sheet included with this application. Specific references to the provisional application are as follows: Date—26 Mar. 2014; Application #—61970437; Confirmation #—8867; EFS ID #—18585122.

### STATEMENT ON FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The field of endeavor to which the invention pertains is entertainment technology. More specifically, it relates to commercial movie distribution and viewing. However, the subject matter for WebCinema is not found in the U.S. patent classification definitions.

The technology is an online viewing platform that allows first-run movies to be viewed on most electronic devices that have internet capability. Game systems and smart TVs, as well as mobile devices such as tablets and smart phones, may need designated application icons (apps). However, electronic devices such as desktop computers and laptop computers may not need the apps because of their existing internal capabilities to access the website and stream movies. This is not Netflix or Hulu, where the consumer is forced to wait for many months to view an anticipated movie. WebCinema is a new and useful process that enables the general public to completely control where and when they choose to conveniently watch new or currently released Hollywood-produced movies.

The conditions and technologies for a process like WebCinema have existed for a while. However, entertainment consumers do not have the freedom to view new movies whenever and wherever they choose. WebCinema wants to empower consumers to have that convenience. The following excerpts support why WebCinema is a viable, desired process that uses existing technology to provide modern society with an alternative to the “old way”.

Before his passing, the legendary innovator and tech visionary Steve Jobs made some quotes where he unknowingly supports the WebCinema process. In 2003, at the first “All Things Digital” Conference, he stated that, “distributing content over the internet is the next big wave.” He was right. And, at the 2010 D8 (All Things Digital) Conference he professed, “they (the music industry) thought their distribution channel was their customer, you know, in the same way that people making movies might think that your movie houses are their customer, but they're not. Their customer is the viewer, just as the music companies' customer is the listener. The music companies had no connection with their listeners, whatsoever, and so what changed in the music industry was not the back end of the business, the A&R, the seeking out and developing of artists and talent, you know, which is just as important now as it ever was. What changed was the front end of the business. The distribution and marketing became, ah, was able to be done in a much more effective way, bypassing the distribution channel and going direct to the end user. And that's what's going to happen in visual media as well. And the marketing is going to get a lot more interesting, more precise, cheaper, and efficient. But the content is going to be just as valuable, if not more valuable in the future. So what the studios need to do, is not, ah, is to embrace this new front end of the business, to start knowing who their customers are and to start building mechanisms to communicate with them, and tell them when their new product is coming out and also to let them watch it wherever they want, whenever they want.” Also at the D8 Conference in 2010, Jobs predicted, “I even think there's going to be a way to watch a first-run movie at home before it comes out on DVD . . . .”

The following comment by Kevin Feige (President of Marvel Studios) was made during an interview with the website “Collider” (collider.com), posted by Steve ‘Frosty’ Weintraub on Jul. 22, 2014. Feige was asked: “Have you guys ever thought of doing an extended version in theaters with the deleted scenes for fans to see on the big screen? Maybe a week before the Blu-ray's gonna come out?” Feige responded, “We haven't, but I think as film technology gets to a point where you could just do something like that in a room like this and digitally send it to theaters for a week and the cost of distribution isn't that high, maybe we could start doing things like that.”

These excerpts were taken from a story titled “Joss Whedon Releases His Latest Film via Vimeo for $5 (Video)”, that appeared in the “The Hollywood Reporter” (hollywoodreporter.com) and posted by Patrick Brzeski on Apr. 21, 2014. . . . The latest Joss Whedon project to reach the big screen, indie drama “In Your Eyes”, was released simultaneously on all manner of small screens during its world premiere at the Tribecca Film Festival on Sunday night. “The Avengers” director's production company, Bellwether Pictures, announced that it was making the film available on its website via Vimeo for $5 immediately following the screening in New York. Whedon commented, “It's not just the world premiere of the film, it's the worldwide release date, because as of now, “In Your Eyes” is available on any Internet-cable device.”. . . . “In Your Eyes” is available for 72-hour rental for $5 via Vimeo at inyoureyesmovie.com. Vimeo is part of Barry Diller's Internet conglomerate IAC. “This is exciting for us because it means we get to explore yet another new form of distribution—and we get $5,” Whedon said.

During an interview with Cynthia McFadden on a segment of the NBC Nightly News with Brian Williams (Aug. 11, 2014), actor Kevin Spacey explained the amazing success of the Netflix original series “House of Cards”. He said, “We're in some ways demonstrating that we've learned the lesson that the music industry didn't learn, . . . give people what they want, when they want it, at a reasonable price, and the chances are they'll buy it and they won't steal it”.

The following excerpts are from an online article titled “Popcorn Time Is Like Netflix For Pirated Content”, by Matt Burn in 2014 (exact date not available). . . . Think of Popcorn Time like Netflix, just with movies worth watching. Find a title and click ‘Watch It Now’. That's it. All the videos are free. And slightly illegal. . . . Technically, these videos are copyrighted and the sheer ease of use of Popcorn Time is not going to make Hollywood happy. Popcorn Time is the easiest way to pirate movies yet. . . . Popcorn Time is how consumers want to consume media. Click a button and the video plays. Netflix, Amazon and others are attempting to bring this sort of experience to the masses, and their growth numbers show consumers are latching on. Yet Hollywood is slow to embrace the future by keeping its best content away from these legit streaming services. . . . It will be months if not years for Netflix and Amazon Instant to gain access to most of the content currently available for streaming on Popcorn Time. And that's why programs, services and the entire pirating industry are thriving.

On Jul. 23, 2013, Scott Bowles reported for the USA TODAY in an article titled “Movie Ticket Prices Jump to All-time High—Movie tickets jump to their highest average ever, sparking a debate over whether the Cineplex is getting too expensive for a night on the town”. For the article, he interviewed April Masini, columnist for askapril.com and author of four dating-advice books, who warns that the industry is flirting with losing its favorite demographic. She states that, “movie tickets are the prime resource for a Saturday night date, and when you start up-pricing movie tickets, you're edging out high school kids, college kids and millennials.”. . . “While $8 is the average price, in most urban areas $8 is the matinee bargain price,” she added. “With Saturday night movie tickets hitting the $15 and $20 mark, add $20 for pricey popcorn and giant drinks, and dinner before or after the movie, and a date night is easily at the $100-$150 mark. And then don't forget to pay the babysitter.”

WebCinema transforms the current state of new-movie viewing technology by allowing consumers to have complete choice. For 100 years, the public has been conditioned, or forced, to view new-release movies the same old way—they had to travel to a theater. Or, we could wait for many months and finally view a movie on Blu-ray/DVD, On-Demand, or through a subscription service. While going out to the movies could be viewed as a traditional part of Americana, technology has made it possible for today's modern society to have control, convenience and choice over their movie viewing options. WebCinema is not just a new and useful process for viewing first-run movies, it provides people with that control, convenience, and choice. New-movie viewing will finally, and legally, expand beyond the theater and directly to the viewer!

WebCinema also eradicates all the problems and inconveniences of traveling to the movie theater. It will eliminate the trip to the theater, the cost of gas, limited show times, standing in long lines on opening weekend, sold out showings, the outrageous cost of refreshments, using public restrooms, stepping on “sticky stuff”, being forced into bad seats at a crowded theater, sitting in an unclean seat, being stepped on, endless previews, plus the annoying people talking behind you and texting in front of you! WebCinema also eliminates some potential health hazards. The TV newsmagazine 20/20 (ABC, Mar. 7, 2014), reported that no laws exist requiring movie theaters to be cleaned. Investigators found numerous traces of bacteria related to food poisoning, feces, and staph. They also uncovered roaches, rodents, bedbugs, and used condoms!

There is also logical evidence that suggests a process like WebCinema would reduce the piracy problem of new-release movies. With new movies available to the public as online content, they are completely accessible, totally convenient to view, and the video quality will be better. Also, with having new-movies available online the day they're released, “piraters” would have little incentive to steal movies. For these reasons, law-abiding consumers should be more likely to pay to view a new movie instead of risking the legal implications involved with accepting pirated materials.

### BRIEF SUMMARY OF THE INVENTION

The general idea behind WebCinema uses existing online viewing platform technology to create a process. That process provides consumers with the ability to view new-release or currently released Hollywood movies from their internet-capable devices. By simply accessing our app or getting on the WebCinema website, the public can eliminate all the problems, inconveniences, and potential health hazards associated with a trip to the theater (see paragraph 15). For approximately the same price as a movie theater ticket, customers can purchase a virtual ticket through a secure payment system and watch a new movie on its release date from anywhere they choose. With WebCinema, the viewer “runs the show”!

The advantages of using WebCinema are many. Overall, it gives the consumer freedom, choice, convenience, and control over their movie watching experience. And, it's an alternative choice to movie theaters because it eliminates all the problems and inconveniences of going to the movies. WebCinema is great for anyone who lives in a rural area and wants to save money, gas and time. It's great for the home theater owner who doesn't like crowds, but likes making their own showtimes and popcorn. WebCinema is great for anyone with an internet-capable device who wants the convenience of watching new-release movies. Add on an easy to use app, website and a secure payment system (currently under construction), and WebCinema is a great new addition to the modern entertainment landscape.

The problems and inconveniences that currently exist with traveling to a theater and viewing new-release movies are identified in the “Background of the Invention” section, paragraphs 14, 15 and 16. In those paragraphs, as problems were identified, we believed it to be more efficient to present solutions to those problems as they were addressed. Therefore, please review paragraphs 14, 15 and 16 for how WebCinema solves all the existing problems and inconveniences related to viewing new-release movies at a movie theater.

### BRIEF DESCRIPTION OF THE SEVERAL VIEWS OF THE DRAWING

“Not Applicable”

### DETAILED DESCRIPTION OF THE INVENTION

As previously stated, WebCinema is an online viewing platform for new and currently released Hollywood-produced movies. The movies can be viewed on any electronic devices that have internet capability. Desktop computers and laptop computers have existing internal capabilities to access the website and stream movies, while game systems, smart TVs, and mobile devices such as tablets and smart phones may need designated application icons (apps) to stream movies. WebCinema is also a simple process that uses existing technology to give the general public more freedom, choice, convenience and control over their new-movie viewing options.

Using WebCinema is quick and simple with two ways to access WebCinema movies. First, the public can search and find our official website from their electronic devices. Second, the public can download the WebCinema app from their mobile app store, or from a link on the website. Next, customers can browse lists of “coming soon” movies, “new release” movies, and “current run” movies that are still playing. There may also be a “special run” section that features categories of older favorites. When customers decide to watch an offered movie, they can purchase a virtual ticket for a one-time viewing of that movie. The virtual ticket can be purchased with a bankcard or through a previously saved account that allows for quicker and easier access. A customer account can be set up on the website at any time during navigation and all purchases are made through a secure payment system. In addition to viewing lists, purchasing a virtual ticket, and setting up an account, browsers can watch trailers and share thoughts with friends through social media integration like Facebook and Twitter. Once the movie is purchased, the viewer has until the movie is removed from the website to watch it once.

What distinguishes WebCinema from entities like Netflix, Hulu and Amazon Prime, is that WebCinema provides the public with access to new movies before and during the time they are in theaters (see paragraph 6). What makes WebCinema new, and distinguishes it from the old way of doing things is that it's not a movie theater (see paragraphs 7, 14 and 15).

The process of how WebCinema works is very simple. As per contracts and agreements with movie studios and distributors, WebCinema is provided with advance digital copies of soon-to-be released movies. WebCinema then loads the movies onto its servers and runs multiple tests for quality and readiness. On the release date (opening day) of a movie, as determined by the studio or distributor, WebCinema will offer the new movie on its app and website.

1. The claim of the inventor is that WebCinema is a new and useful process that provides the general public, through a website and app, with access to purchase streaming, first-run movies before and during the time they appear in theaters.
